(19) United States
(12) Patent Application Publication
(10) Pub. No.: US 2009/0185673 A1
(43) Pub. Date: Jul. 23, 2009

(54) Voice-Over-IP Call Recording in Call Centers

(75) Inventors: George William Erhart, Loveland, CO (US); Valentine C. Matula, Granville, OH (US); David Joseph Skiba, Golden, CO (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 12/016,128

(22) Filed: Jan. 17, 2008

(51) Int. Cl. H04M 3/00

(52) U.S. Cl. 379/265.09

(57) ABSTRACT

An apparatus and methods are disclosed for recording calls in a Voice over Internet Protocol (VoIP)-based call center. In accordance with the illustrative embodiment, one of a plurality of data-processing systems in the call center is selected for each call to decompress and decrypt the call's media stream(s). The selection criteria include the type of compression algorithm, the type of encryption scheme, the processing capabilities of the data-processing systems, the current processing load of the data-processing systems, and the available communication bandwidth into and out of the data-processing systems. The selected data-processing system is subsequently incorporated into the call path between the calling SIP endpoint and the call center SIP endpoint, if necessary, and for the duration of the call decompresses/decrypts the media stream(s), generates a copy of the decompressed/decrypted stream(s), and transmits the copied stream(s) to a recording device in the call center.

### FIELD OF THE INVENTION

The present invention relates to security in general, and, more particularly, to peer authentication.

### BACKGROUND OF THE INVENTION

Call centers routinely record callers' conversations for a variety of reasons including quality assurance, agent monitoring and training, and customer satisfaction evaluation. The salient elements of a typical call center of the prior art are depicted in FIG. 1.

Call center 100 of FIG. 1 comprises interactive voice response system (IVR) 110, agent terminals 120-1 through 120-N, where N is a positive integer, switch 130, and recording device 140, interconnected as shown.

Interactive voice response (IVR) system 110 is a data-processing system that is capable of presenting one or more menus to a caller, of receiving and processing input from a caller (e.g., speech signals, keypad input, etc.), and of sending a command to switch 130 to re-direct a call to one of agent terminals 120-1 through 120-N.

Agent terminal 120-i, where i is an integer between 1 and N inclusive, is a telephone, telecommunications device for the deaf (TDD), etc. that enables a human call-center agent to communicate with a caller over a telephone line.

Switch 130 is a data-processing system (e.g., a private branch exchange [PBX], etc.) that interfaces with an external network (e.g., the Public Switched Telephone Network [PSTN], etc.) and is capable of establishing a connection between a caller external to call center 100 and either IVR 110 or any one of agent terminals 120-1 through 120-N. In addition, switch 130 is capable of generating a copy of the audio or text of the incoming calls and sending the generated copy to recording device 140.

Recording device 140 is a memory (e.g., hard disk, tape, random-access memory [RAM], etc.) that is capable of receiving an audio or text stream and of storing the stream for subsequent retrieval.

### SUMMARY OF THE INVENTION

In a call center that is based on the Voice over Internet Protocol (VoIP) in lieu of conventional telephony, the audio of Voice over Internet Protocol (VoIP) calls might be compressed (e.g., via H.729 or Global System for Mobile communications [GSM] speech compression, etc.), or encrypted (e.g., via Secure Real-time Transport Protocol [RTP], etc.), or both. As a result, in a Voice over Internet Protocol (VoIP)-based call center it is necessary to decompress and decrypt the audio stream of calls for comprehension by one or both of the calling and called parties, as well as for generating meaningful recordings of conversations. Furthermore, because there is no central switch in a Voice over Internet Protocol (VoIP)-based call center for generating copies of calls' audio and sending the copies to a recording device, potentially any one of the data-processing systems of the call center (e.g., an interactive voice response [IVR] system, a Session Initiation Protocol [SIP] proxy, a session border controller [SBC], a server, etc.) could carry out the decompression and decryption of a call's audio stream and send the decompressed, decrypted audio to a recording device. Consequently, it might be desirable to select, for each individual call, a particular element of the call center to perform decompression and decryption.

The illustrative embodiment of the present invention selects, for each incoming call to a VoIP-based call center, which of the data-processing systems of the call center will perform the decompression and decryption of the call's audio stream. This selection is based on a variety of factors, including the type of compression algorithm (and consequently, the processing requirements for decompressing the audio stream), the type of encryption scheme (and consequently, the processing requirements for decrypting the audio stream), the processing capabilities of the data-processing systems, the current processing load of the data-processing systems, the available communication bandwidth into and out of the data-processing systems, etc. The selected data-processing system is subsequently incorporated into the call path between the calling SIP endpoint and the call center SIP endpoint, if necessary, and for the duration of the call decompresses/decrypts the audio stream, generates a copy of the decompressed/decrypted stream, and transmits the copied stream to a recording device in the call center.

In addition to decompressing, decrypting, and recording audio streams, the illustrative embodiment of the present invention is also capable of decompressing, decrypting, and recording video streams in conjunction with, or instead of, audio streams.

The illustrative embodiment comprises: receiving a signal that is part of a call; and selecting one of a plurality of data-processing systems to generate a recording of the call based on what type of compression is employed for the call.

### BRIEF DESCRIPTION OF THE DRAWINGS

FIG. 1 depicts a schematic diagram of the salient elements of call center 100, in accordance with the prior art.

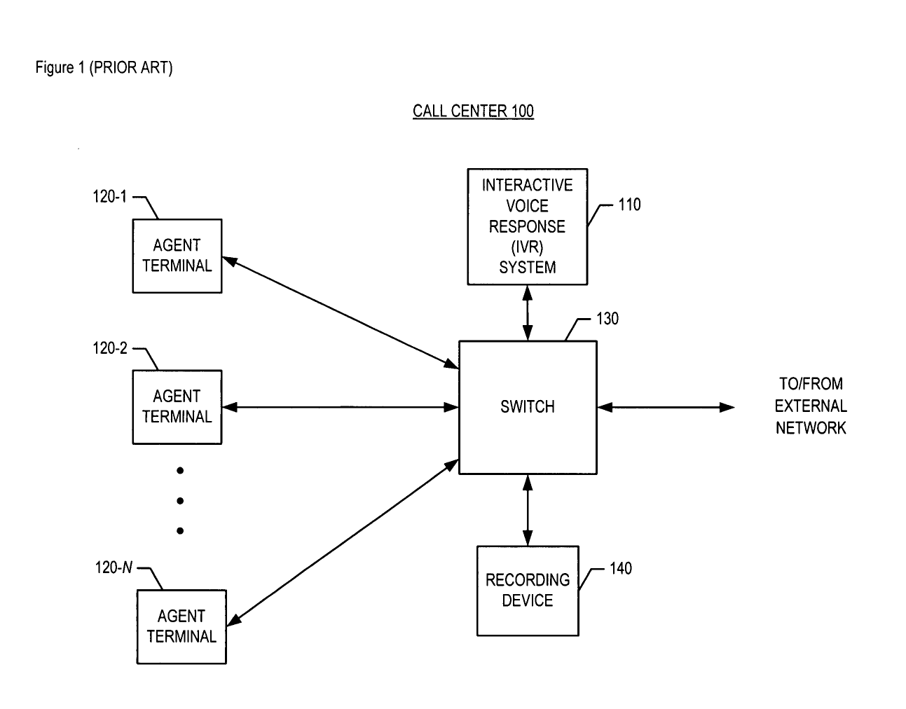

FIG. 2 depicts a schematic diagram of the salient elements of Voice over Internet Protocol (VoIP)-based call center 200, in accordance with the illustrative embodiment of the present invention.

FIG. 3 depicts a flowchart of the salient tasks of the illustrative embodiment.

FIG. 4 depicts a detailed flowchart for task 350, as shown in FIG. 3, in accordance with the illustrative embodiment of the present invention.

### DETAILED DESCRIPTION

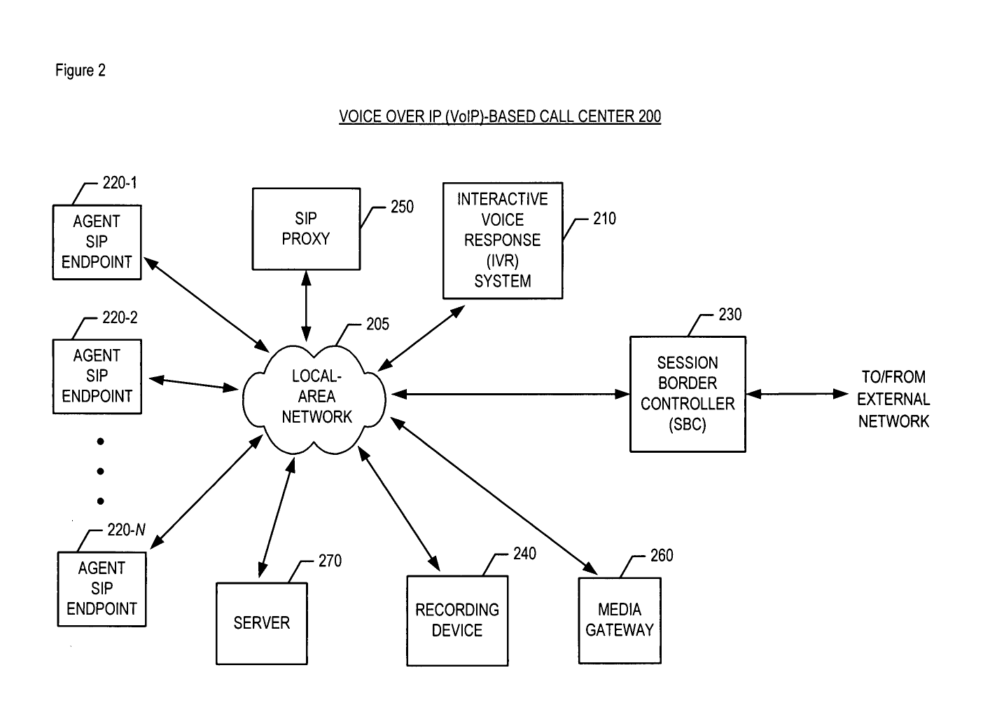

FIG. 2 depicts a schematic diagram of the salient elements of Voice over Internet Protocol (VoIP)-based call center 200, in accordance with the illustrative embodiment of the present invention. As shown in FIG. 2, Voice over Internet Protocol (VoIP)-based call center 200 comprises local-area network (LAN) 205, interactive voice response (IVR) system 210, agent Session Initiation Protocol (SIP) endpoints 220-1 through 220-N, where N is a positive integer, session border controller (SBC) 230, recording device 240, media gateway 260, Session Initiation Protocol (SIP) proxy 250, and server 270, interconnected as shown.

Local-area network (LAN) 205 is capable of transporting signals among interactive voice response (IVR) system 210, agent Session Initiation Protocol (SIP) endpoints 220-1 through 220-N, session border controller (SBC) 230, recording device 240, media gateway 260, Session Initiation Protocol (SIP) proxy 250, and server 270, in well-known fashion.

Interactive voice response (IVR) system 210 is a data-processing system that is capable of transmitting and receiving signals via local-area network (LAN) 205, of presenting one or more menus to a caller, of receiving and processing input from a caller (e.g., speech signals, keypad input, etc.), of re-directing a call to one of agent SIP endpoints 220-1 through 220-N. In addition, interactive voice response (IVR) system 210 is capable of functioning as a Session Initiation Protocol (SIP) endpoint, of decompressing one or more types of media streams (e.g., H.729 audio streams, H.263 video streams, etc.), and of decrypting one or more types of media streams, in well-known fashion.

Agent Session Initiation Protocol (SIP) endpoint 220-i, where i is an integer between 1 and N inclusive, is a SIP-capable telecommunications terminal that enables a human call-center agent to communicate with a caller. In addition, agent SIP endpoint 220-i, where i is an integer between 1 and N inclusive, is capable of transmitting and receiving signals via local-area network (LAN) 205, of decompressing one or more types of media streams (e.g., H.729 audio streams, H.263 video streams, etc.), and of decrypting one or more types of media streams, in well-known fashion.

Session border controller (SBC) 230 is a data-processing system that acts as an interface between Voice over Internet Protocol (VoIP)-based call center 200 and an external network (e.g., the Internet, the Public Switched Telephone Network [PSTN], etc.), controlling Voice over Internet Protocol (VoIP) traffic that arrives at call center 200 via the external network, and that originates at call center 200 and is to be transmitted over the external network. Session border controller (SBC) 230 is capable of transmitting and receiving signals via local-area network (LAN) 205, and as is well-known in the art, of performing a variety of functions related to signaling, network address translation (NAT), security/access control, Real-time Transport Protocol (RTP) flow control, and so forth. Session border controller (SBC) 230 is also capable of decompressing one or more types of media streams (e.g., H.729 audio streams, H.263 video streams, etc.), and of decrypting one or more types of media streams, in well-known fashion.

Recording device 240 is a memory (e.g., hard disk, tape, random-access memory [RAM], etc.) that is capable of receiving media streams via local-area network (LAN) 205, and of storing these media streams for subsequent retrieval.

Session Initiation Protocol (SIP) proxy 250 is a data-processing system that is capable of transmitting and receiving signals via local-area network (LAN) 205, and as is well-known in the art, of performing a variety of functions including Voice over Internet Protocol (VoIP) call path setup, user authentication and authorization, call-routing policy implementation and enforcement, and so forth. Session Initiation Protocol (SIP) proxy 250 is also capable of decompressing one or more types of media streams (e.g., H.729 audio streams, H.263 video streams, etc.), and of decrypting one or more types of media streams, in well-known fashion.

Media gateway 260 is a data-processing system that is capable of converting between the different transmission and coding techniques of the external network and the elements of Voice over Internet Protocol (VoIP)-based call center 200, and of performing media streaming functions such as echo cancellation and Dual-Tone Multi-Frequency (DTMF) signaling, as is well-known in the art. Media gateway 260 is also capable of receiving and transmitting signals via local-area network (LAN) 205, of decompressing one or more types of media streams (e.g., H.729 audio streams, H.263 video streams, etc.), and of decrypting one or more types of media streams, in well-known fashion.

Server 270 is a data-processing system that is capable of transmitting and receiving signals via local-area network (LAN) 205, and of hosting one or more software applications (e.g., applications that are accessed by human agents via desktop personal computers [not shown in FIG. 2], applications that are accessed by interactive voice response [IVR] system 210, etc.), in well-known fashion. In addition, server 270 is capable of decompressing one or more types of media streams (e.g., H.729 audio streams, H.263 video streams, etc.), and of decrypting one or more types of media streams, in well-known fashion.

As will be appreciated by those skilled in the art, Voice over Internet Protocol (VoIP)-based call center 200 might contain other data-processing systems not depicted in FIG. 2, such as one or more additional Session Initiation Protocol (SIP) proxies, one or more additional servers, one or more additional recording devices, an intrusion prevention appliance, etc., and it will be clear to those skilled in the art, after reading this disclosure, how to make and use embodiments of the present invention in call centers that contain such data-processing systems.

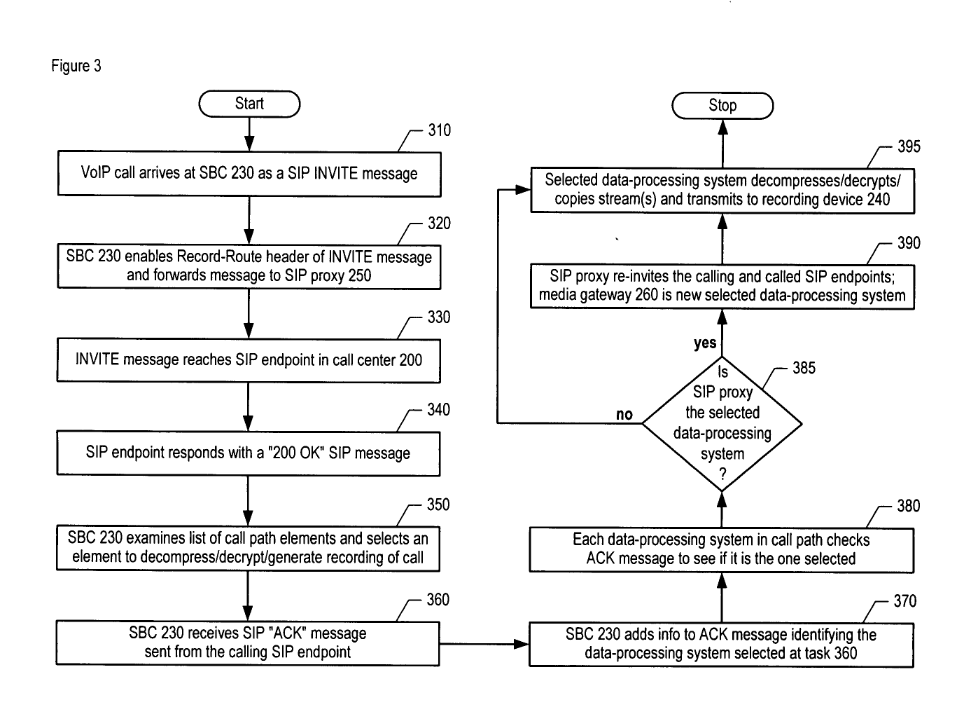

FIG. 3 depicts a flowchart of the salient tasks of the illustrative embodiment. It will be clear to those skilled in the art, after reading this disclosure, which tasks depicted in FIG. 3 can be performed simultaneously or in a different order than that depicted.

At task 310, a Voice over Internet Protocol (VoIP) call arrives at session border controller (SBC) 230 as a Session Initiation Protocol (SIP) “INVITE” message, in well-known fashion.

At task 320, session border controller (SBC) 230 enables the “Record-Route” header of the INVITE message and forwards the message (via local-area network [LAN] 205) to Session Initiation Protocol (SIP) proxy 250, in well-known fashion. As is well-known in the art, the Record-Route feature ensures that Session Initiation Protocol (SIP) proxy 250 (as well as any other SIP proxies in the call path) remains in the call path for all SIP signaling, and causes SIP proxy 250 (as well as any other SIP proxies in the call path) to add a “Via:” header with its address to each packet.

At task 330, the INVITE message reaches its SIP endpoint (i.e., either interactive voice response (IVR) system 210 or one of agent SIP endpoints 220-i, where i is an integer between 1 and N inclusive), in well-known fashion.

At task 340, the SIP endpoint responds with a “200 OK” SIP message that passes back through Session Initiation Protocol (SIP) proxy 250 (and any other SIP proxies of call center 200 that are in the call path but are not depicted in FIG. 2) to session border controller (SBC) 230, in well-known fashion.

At task 350, session border controller (SBC) 230 examines the list of call path elements (e.g., Session Initiation Protocol [SIP] proxy 250, etc.) and selects an element to decompress/decrypt the call and generate a recording of the call, as described in detail below and with respect to FIG. 5.

At task 360, session border controller (SBC) 230 receives a SIP “ACK” message that is sent from the calling SIP endpoint, in well-known fashion.

At task 370, session border controller (SBC) 230 adds information to the ACK message (e.g., via a custom SIP header, etc.) that identifies the data-processing system selected at task 360, in well-known fashion.

At task 380, each data-processing system in the call path checks the ACK message to see if it is the one selected for decompression/decryption of the call media stream(s) and copying/transmission of the decompressed/decrypted stream(s) to recording device 240, in well-known fashion.

At task 385, a branch statement checks whether the selected data-processing system is Session Initiation Protocol (SIP) proxy 250 (or another SIP proxy in call center 200 not depicted in FIG. 3). If not, execution continues at task 395, otherwise continues proceeds to task 390.

At task 390, Session Initiation Protocol (SIP) proxy 250 (or whichever SIP proxy is selected at task 350) “re-invites” the calling and called SIP endpoints (i.e., transmits new INVITE messages to both endpoints) such that a new call path is established through media gateway 260, and media gateway 260 is identified as the new “selected data-processing system” via an SDP (Session Description Protocol) definition, in well-known fashion.

At task 395, the selected data-processing system decompresses and decrypts the call's media stream(s), generates a copy of the decompressed/decrypted stream(s), and transmits the copied stream(s) to recording device 240—in addition to its usual functions during the call. Task 390 is performed for the duration of the call, and upon completion of the call, the method of FIG. 3 terminates.

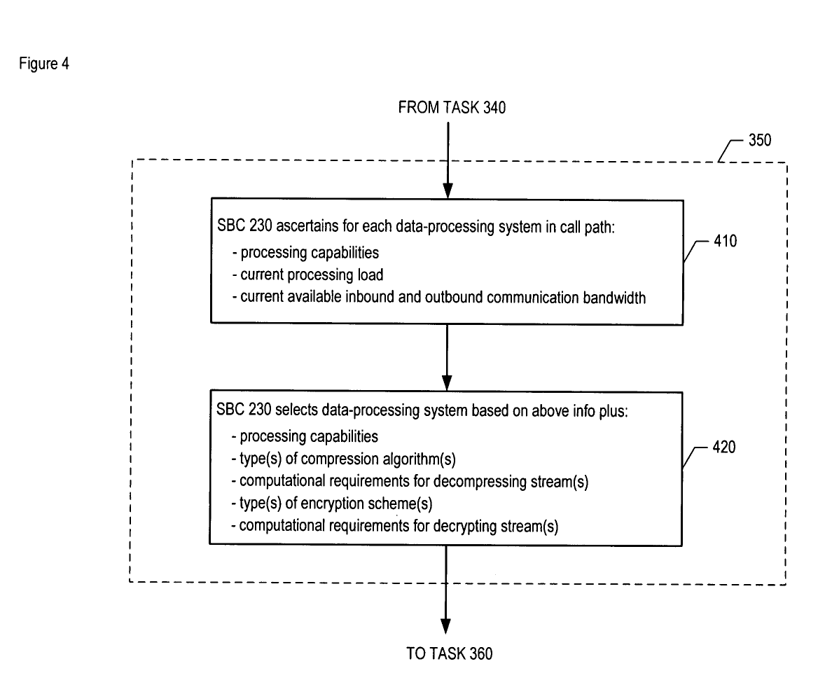

FIG. 4 depicts a detailed flowchart for task 350, as shown in FIG. 3, in accordance with the illustrative embodiment of the present invention. It will be clear to those skilled in the art, after reading this disclosure, which tasks depicted in FIG. 4 can be performed simultaneously or in a different order than that depicted.

At task 410, session border controller (SBC) 230 ascertains the following information for each of the data-processing systems in the call path:
its processing capabilities (e.g., the Gigaflops rating of its CPU, etc.),
its current processing load (e.g., CPU utilization expressed as a percentage, etc.), and
its current available inbound and outbound communication bandwidth.

As will be appreciated by those skilled in the art, there are a variety of ways in which this information might be ascertained by session border controller (SBC) 230. For example, in some embodiments of the present invention each data-processing system in the call path might add this information to one of the SIP messages (e.g., an ACK message, a “200 OK” message, etc.) via a custom SIP header or some other mechanism, while in some other embodiments session border controller (SBC) 230 might send messages to the data-processing systems requesting this information, while in still other embodiments the data-processing systems might periodically update this information in a directory that session border controller (SBC) 230 can access.

At task 420, session border controller (SBC) 230 selects one of the data-processing systems based on the above information, in conjunction with:
the type(s) of compression algorithm(s) employed in the call's media stream(s),
the computational requirements for decompressing stream(s) that are compressed with the above algorithm(s),
the type(s) of encryption scheme(s) employed in the call's media stream(s), and
the computational requirements for decrypting stream(s) that are encrypted with the above scheme(s).

As will be appreciated by those skilled in the art, there are a variety of different ways in which the above criteria might factor into the selection of a particular data-processing system. For example, in some embodiments of the present invention the selection might be performed with the objective of minimizing the maximum CPU utilization rate over all of the data-processing systems in VoIP-based call center 200, while in some other embodiments the selection might be performed with the objective of achieving relatively uniform CPU utilization rates across the data-processing systems of call center 200, while in still other embodiments the selection might be performed with the objective of adding as little incremental “cost” to a particular processing cost metric (i.e., a so-called “greedy” selection strategy). In any case, it will be clear to those skilled in the art, after reading this disclosure, how to make and use embodiments of the present invention that employ such selection strategies, as well as other kinds of selection strategies that might be advantageous in particular implementations or environments.

After task 420 is completed, execution proceeds to task 360 of FIG. 3.

As will be appreciated by those skilled in the art, although in the illustrative embodiment the task 350 of FIG. 3 and tasks 410 and 420 of FIG. 4 are performed by session border controller (SBC) 230, it will be clear to those skilled in the art, after reading this disclosure, how to make and use embodiments of the present invention in which some other data-processing system of call center 200 (e.g., server 270, Session Initiation Protocol [SIP] proxy 250, etc.) performs these tasks.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving a signal that is part of a call; and
selecting one of a plurality of data-processing systems to generate a recording of said call based on what type of compression is employed for said call.

2. The method of claim 1 wherein said call is a Voice over Internet Protocol call.

3. The method of claim 1 wherein said plurality of data-processing systems are nodes along the route of said call.

4. The method of claim 1 wherein said plurality of data-processing systems are elements of a call center.

5. The method of claim 1 wherein at least one of said plurality of data-processing systems is a session border controller.

6. The method of claim 1 wherein at least one of said plurality of data-processing systems is a Session Initiation Protocol proxy.

7. The method of claim 1 wherein a data-processing system that is external to the route of said call is selected, and wherein said route is modified to include the selected data-processing system.

8. A method comprising:
receiving a signal that is part of a call; and
selecting one of a plurality of data-processing systems to generate a recording of said call based on what type of encryption is employed for said call.

9. The method of claim 8 wherein said call is a Voice over Internet Protocol call.

10. The method of claim 8 wherein said plurality of data-processing systems are nodes along the route of said call.

11. The method of claim 8 wherein said plurality of data-processing systems are elements of a call center.

12. The method of claim 8 wherein at least one of said plurality of data-processing systems is a session border controller.

13. The method of claim 8 wherein at least one of said plurality of data-processing systems is a Session Initiation Protocol proxy.

14. The method of claim 8 wherein a data-processing system that is external to the route of said call is selected, and wherein said route is modified to include the selected data-processing system.

15. A method comprising:
transmitting from a first data-processing system a first message to a first endpoint and a second message to a second endpoint, wherein said first data-processing system is along an existing path of a call from said first endpoint to said second endpoint, and wherein said first message re-directs subsequent messages that are sent by said first endpoint and directed to said second endpoint to a second data-processing system instead, and wherein said second message re-directs subsequent messages that are sent by said second endpoint to said first endpoint to said second data-processing system instead;
generating at said second data-processing system a recording of said subsequent messages that are sent by said first endpoint and said subsequent messages that are sent by said second endpoint;
forwarding said subsequent messages that are sent by said first endpoint to said second endpoint; and
forwarding said subsequent messages that are sent by said second endpoint to said first endpoint.

16. The method of claim 15 wherein said first message and said second message are Session Initiation Protocol INVITE messages.

17. The method of claim 15 wherein said subsequent messages that are sent by said first endpoint and said subsequent messages that are sent by said second endpoint are Real-time Transport Protocol messages.

18. The method of claim 15 wherein said first data-processing system and said second data-processing system are elements of a call center.

19. The method of claim 15 wherein said first data-processing system is one of a Session Initiation Protocol proxy and a session border controller.

20. The method of claim 15 wherein said second data-processing system is a media translation gateway.
